(19) United States
(12) Patent Application Publication
(10) Pub. No.: US 2026/0168531 A1
(43) Pub. Date: Jun. 18, 2026

(54) BEARING ARRANGEMENT AND WIND TURBINE

(71) Applicants: ZF Friedrichshafen AG, Friedrichshafen (DE); ZF Wind Power Antwerpen N.V., Lommel (BE)

(72) Inventors: Priyangu PATEL, Friedrichshafen (DE); Wim DE LAET, Antwerpen (BE)

(21) Appl. No.: 19/420,835

(22) Filed: Dec. 16, 2025

(30) Foreign Application Priority Data
Dec. 17, 2024 (DE) 10 2024 212 030.8

(51) Int. Cl. F16C 19/36

(52) U.S. Cl. CPC F16C 19/364; F16C 2360/31

(57) ABSTRACT

A bearing arrangement for a rotor shaft of a wind turbine, including a housing and at least one bearing. The at least one bearing is fastened in the housing with an outer ring. The at least one bearing is configured to be fastened to the rotor shaft with an inner ring. The bearing arrangement is formed to adjust an axial force acting on the outer ring in order to specify a preload of the at least one bearing.

### CROSS REFERENCE TO RELATED APPLICATIONS

This application claims benefit to German Patent Application No. DE 10 2024 212 030.8, filed on Dec. 17, 2024, which is hereby incorporated by reference in its entirety herein.

### FIELD

The present invention relates to a bearing arrangement for a rotor shaft of a wind turbine and to a wind turbine.

### BACKGROUND

Wind turbines serve to generate electricity from wind energy. For this purpose, wind turbines have a rotor. A rotational speed of the rotor is transmitted from a rotor shaft to a gearbox. The rotational speed of the rotor shaft is translated by the gearbox into a suitable rotational speed to drive a generator. A rotational speed and the loads acting on the rotor can fluctuate during operation of the wind turbine, for example, due to gusts of wind. Rotors can also have a large diameter and be very heavy. This places significant and changing loads on the bearings for the rotor shaft. Accordingly, these bearings require frequent maintenance and, alternatively or additionally, complex monitoring. Therefore, high precision is required during assembly to avoid excessive wear due to deviations from a specified assembly state.

### SUMMARY

In an embodiment, the present disclosure provides a bearing arrangement for a rotor shaft of a wind turbine, comprising a housing and at least one bearing. The at least one bearing is fastened in the housing with an outer ring. The at least one bearing is configured to be fastened to the rotor shaft with an inner ring. The bearing arrangement is formed to adjust an axial force acting on the outer ring in order to specify a preload of the at least one bearing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a wind turbine;

FIG. 2 schematically illustrates in a sectional view a conventional bearing arrangement for a rotor shaft of the wind turbine;

FIG. 3 schematically illustrates in a sectional view an embodiment of the bearing arrangement;

FIG. 4 schematically illustrates in a sectional view an embodiment of the bearing arrangement;

FIG. 5 schematically illustrates in a sectional view an embodiment of the bearing arrangement;

FIG. 6 schematically illustrates in a sectional view an embodiment of the bearing arrangement in cut-out;

FIG. 7 schematically illustrates in a sectional view an embodiment of the bearing arrangement in cut-out;

FIG. 8 schematically illustrates in a sectional view an embodiment of the bearing arrangement in cut-out;

FIG. 9 schematically illustrates in a side view an embodiment of a housing of the bearing arrangement;

FIG. 10 illustrates schematically in a side view an embodiment of a housing of the bearing arrangement;

FIG. 11 schematically illustrates in a perspective view an embodiment of a housing of the bearing arrangement;

FIG. 12 illustrates schematically in a perspective view a multi-part cover element of the bearing arrangement;

FIG. 13 schematically illustrates in a perspective view a segment of the multi-part cover element in cut-out; and

FIG. 14 schematically illustrates in another perspective view the segment of the multi-part cover element in cut-out.

### DETAILED DESCRIPTION

In an embodiment, the present disclosure provides a bearing arrangement for a rotor shaft of a wind turbine. The wind turbine can have a tower and a nacelle arranged thereon. The tower extends, for example, with its longitudinal extent in a vertical direction. The nacelle can be mounted on the tower, for example, in a rotatable or rotationally fixed manner. The nacelle can be arranged on top of the tower, for example. The tower can be formed to be hollow, for example. The tower can taper towards its upper end.

The wind turbine can, for example, have a rotor, a gearbox, and a generator. The rotor can drive the generator via the gearbox to generate electrical energy. The rotor is, for example, connected to the gearbox via a rotor shaft. The rotor, the gearbox, and the generator can, for example, be attached to a nacelle of the wind turbine. The rotor shaft can be rotatably mounted in the nacelle. The rotor can have a horizontal or a vertical axis of rotation. The rotor can, for example, have two, three, four, or more rotor blades, which are connected to the rotor shaft via a hub. The rotor shaft, the gearbox, and the generator can, for example, form parts of a drive train of the wind turbine. The rotor shaft can be part of the bearing arrangement or form a separate part. The axis of rotation of the rotor and also of the rotor shaft can define an axial direction and a radial direction of the bearing arrangement.

The bearing arrangement has a housing and at least one bearing. The housing and the at least one bearing can form a main bearing for the drive train of the wind turbine. The drive train of the wind turbine can, for example, be fastened to the nacelle exclusively via the main bearing. The main bearing can have multiple bearings, for example, exactly two bearings. For the sake of simplicity, the term “bearing” is used below, although respective features and properties can also relate to other bearings, if present and applicable. The housing can be formed in one piece or in multiple parts. The housing can, for example, be a cast or forged part. The housing can be fastened to the nacelle, for example, by being screwed to a machine bed. The housing and the machine bed can be separate components. The bearing can, for example, be formed as a rolling bearing. The rotor shaft can be rotatably mounted on the housing by means of the bearing.

The bearing has an outer ring and an inner ring. The inner ring can be rotatable relative to the outer ring about the axis of rotation. Rolling elements can be arranged between the outer ring and the inner ring. The bearing is fastened in the housing with the outer ring. For example, the outer ring can bear against an inner circumference of the housing with its outer circumference. The outer ring can also bear against the housing end face in some areas, at least on one axial side, for example, against a shoulder of the housing. The bearing is fastened to the rotor shaft with an inner ring. For example, the inner ring can bear against an outer circumference of the rotor shaft with an inner circumference. The inner ring can also bear against the rotor shaft end face in some areas, at least on one axial side, for example, against a shoulder of the housing.

The bearing can, for example, be arranged in the housing. The nacelle can, for example, have the machine bed to which the drive train is fastened. The rotor shaft can be mounted on the nacelle only via the main bearing. The gearbox can, for example, also be mounted on the nacelle only via the main bearing. In this case, for example, stationary components of the housing, such as a gearbox housing, are fastened to the housing. At least one rotatable part, such as an input shaft of the gearbox, can be mounted on the bearing via the rotor shaft. Optionally, the generator can also be mounted on the nacelle only via the main bearing, for example, indirectly via the gearbox.

The outer ring can be seated in the housing with a press fit, transition fit, or clearance fit, for example. Alternatively or additionally, the outer ring can be clamped on or screwed to the housing. The inner ring can be seated on the rotor shaft with a press fit, transition fit, or clearance fit, for example. Alternatively or additionally, the inner ring can be clamped on or screwed to the rotor shaft. The pressure due to the fit of the inner ring with the rotor shaft can be greater than the pressure due to the fit of the outer ring with the housing. This can make positioning the outer ring easier than positioning the inner ring. Accordingly, a preload on the bearing can be adjusted more easily on the outer ring than on the inner ring. However, in wind turbines, the bearing preload is usually adjusted on the inner ring. Due to the usual tight press fit, the preload is often only adjustable imprecisely and is also highly temperature-dependent.

In the present case, the bearing arrangement according to an embodiment is formed to adjust an axial force acting on the outer ring in order to specify a preload of the bearing. For example, prior to commissioning, the outer ring can be axially displaced relative to the inner ring by applying the axial force in order to adjust a preload. The preload can correspond to a bearing clearance. A preload can be a force with which the inner ring and the outer ring are pressed against each other when stationary. The preload can be an axial preload. The preload can adjust the bearing. The preload can also act on further bearings, such as a second bearing of the main bearing. A precisely adjusted preload can increase a rigidity of the bearing and, alternatively or additionally, increase running accuracy. Furthermore, precise guidance of the rotor shaft, compensation of wear and settling processes during operation, and an overall long service life can be achieved.

The axial position of the outer ring can, for example, be an absolute position, a position relative to the inner ring, or, alternatively or additionally, a position relative to the housing. Adjustment can be performed mechanically, for example, by applying an axial force. The outer ring can be pressed in an axial direction with an adjustable force, for example, in the direction of a nearest axial end region of the housing. The bearing arrangement can be formed such that adjustment can be performed when the inner ring is already fastened to the rotor shaft. The bearing arrangement can be formed such that adjustment can be performed when the outer ring is already arranged in the housing. The outer ring can be simultaneously fastened to the housing through adjustment. The outer ring can be subjected to an axial force through adjustment. The bearing arrangement can be formed for appropriate accessibility.

Preload adjustment can be performed, for example, during final assembly. Large wind turbines are typically assembled at their installation site. Various parts of the drive train, such as the main bearing, the rotor shaft (optionally with the hub), the gearbox, and the generator, are initially transported separately to the installation site. Assembly then only takes place there. The bearing arrangement can be formed so that preload adjustment can be performed in the nacelle and during final assembly.

In an embodiment of the bearing arrangement, it can be provided that the bearing is formed as a tapered roller bearing. All bearings of at least the main bearing or the bearing arrangement can also be formed as tapered roller bearings. The bearings can be of single-row or multi-row formation. A tapered roller bearing can be capable of withstanding high axial and radial loads. Two tapered roller bearings can be provided, which are adjusted with respect to each other. The rolling elements of a tapered roller bearing can be formed as tapered rollers. Alternatively, a spherical roller bearing, angular contact ball bearing, or ball roller bearing can be used.

In an embodiment of the bearing arrangement, it can be provided that the bearing arrangement has a locking element detachably fastened to the housing. The locking element can be formed, for example, as a locking ring. The locking element can be a metallic component. The locking element can be formed for fastening to the housing, for example, by means of screws in spaced-apart axial through-openings along its circumference. The outer ring can be held in its axial position in the housing by means of the locking element. For example, the outer ring can be pressed axially against a stop, for example, formed by a shoulder in the housing, by the locking element. The locking element can, for example, press against the outer ring at its end face. Alternatively, in each case a locking element can also be provided axially on each side of the outer ring, between which the outer ring can be clamped, for example.

The bearing arrangement can comprise a set of locking elements with varying distances between a support surface on the housing and the outer ring. For example, the different locking elements can have different thicknesses in the axial direction. When fastened to the housing, forces of varying magnitude act on the outer ring depending on the selected locking element. The axial force can thus be adjusted to match tolerances and the final positioning of the inner ring in the individual wind turbine to achieve the desired preload.

Alternatively or additionally, at least one spacer element can be clamped between the housing and the locking element to adjust the force acting axially on the outer ring. The bearing arrangement can comprise a set of spacer elements with different distances between a support surface on the housing and the locking element. For example, the different spacer elements can have different thicknesses in the axial direction. When clamped to the housing, forces of varying magnitude act on the outer ring depending on the selected spacer element. The axial force can thus be adjusted to match tolerances and the final positioning of the inner ring in the individual wind turbine in order to achieve the desired preload.

The spacer element can be formed, for example, as a spacer ring, packing plate or washer. The spacer element can be formed as a metallic component. The spacer element can simply be clamped in place or, for example, screwed to the housing together with the locking element. If locking elements are provided on both sides of the outer ring, a spacer element can be clamped between only one or between both locking elements and the housing. Spacer elements can also be selectively clamped between an optionally present stop of the housing for the outer ring and the outer ring. The bearing arrangement can, for example, have at least one spacer element.

In an embodiment of the bearing arrangement, it can be provided that the bearing arrangement has a further locking element detachably fastened to the rotor shaft, by means of which the inner ring is held in its axial position in the rotor shaft. The design can be analogous to the holding of the outer ring on the housing by means of the previously described locking element. The further locking element can be formed for fastening to the rotor shaft, for example, by means of screws in spaced-apart axial through-openings. The further locking element can be formed as an interlocking element. The further locking element can, for example, be formed as a nut screwed onto the rotor shaft. The inner ring can be held in its axial position on the outside of the rotor shaft by means of the further locking element. For example, the inner ring can be pressed axially against a stop, for example, formed by a shoulder in the rotor shaft, by the further locking element. The further locking element can, for example, press against the end face of the inner ring. Alternatively, a further locking element can also be provided axially on either side of the inner ring, between which the outer ring can be clamped. A further spacer element can be clamped between the rotor shaft and the further locking element for adjusting a force acting axially on the inner ring. The further locking element can function as an interlocking element, by means of which the inner ring of the bearing is fixed in position.

The bearing arrangement can have a set of further locking elements with varying distances between a support surface on the rotor shaft and the inner ring. For example, the various further locking elements can have different thicknesses in the axial direction. When fastened to the rotor shaft, forces of varying magnitude act on the inner ring depending on the selected further locking element. The axial force can thus be adjusted to match tolerances and the final positioning of the outer ring in the individual wind turbine in order to achieve the desired preload. By adjusting the axial force on the inner ring, a preload can be at least partially specified in a partially assembled state and then finely adjusted on the outer ring, for example, after assembly of the drive train. Furthermore, the axial position of the bearing can thus be specified more precisely.

Alternatively or additionally, at least the further spacer element can be clamped between the rotor shaft and the further locking element to adjust the force acting axially on the inner ring. The bearing arrangement can have a set of further spacer elements with different distances between a support surface on the rotor shaft and the further locking element. For example, the different further spacer elements can have different thicknesses in the axial direction. When clamped to the rotor shaft, forces of varying magnitude act on the inner ring depending on the selected further spacer element. The axial force can thus be adjusted to match tolerances and the final positioning of the outer ring in the individual wind turbine in order to achieve the desired preload.

The further spacer element can be formed, for example, as a spacer ring, packing plate or washer. The further spacer element can be formed as a metallic component. The additional spacer element can simply be clamped in place or, for example, screwed to the rotor shaft together with the further locking element. If further locking elements are provided on both sides of the inner ring, in each case a further spacer element can be clamped in place between only one or both further locking elements and the rotor shaft. Further spacer elements can also be selectively clamped between an optionally present stop of the rotor shaft for the inner ring and the inner ring. The bearing arrangement can, for example, have at least one additional spacer element.

Respective locking elements and associated respective spacer elements can also be formed as a single assembly. For example, the respective locking element and the associated respective spacer element can be formed inseparably. For example, the respective locking element and the associated respective spacer element can be formed in one piece. For example, parts of this assembly, such as a segment, can form in one piece both a part of the respective locking element and the associated respective spacer element, but the assembly can be formed from several parts that are detachably connected to one another.

In an embodiment of the bearing arrangement, it can be provided that respective spacer elements are formed in multiple parts. For example, the spacer element for the outer ring can be formed in multiple parts. For example, the further spacer element for the inner ring can be formed in multiple parts. For example, respective spacer elements can be divided in the circumferential direction. For example, the respective spacer elements can have three segments, each extending 120° of a circular arc. The multi-part design allows for easy installation, for example, through an access opening in a circumferential wall of the housing. The segments can be screwed together, for example. The segments can be aligned with one another by locating pins.

In an embodiment of the bearing arrangement, it can be provided that respective locking elements are formed in multiple parts. For example, the locking element for the outer ring can be formed in multiple parts. For example, the further locking element for the inner ring can be formed in multiple parts. For example, the respective locking elements can be divided in the circumferential direction. For example, the respective locking elements can have three segments, each extending 120° of a circular arc. The multi-part design allows for easy installation, for example, through an access opening in a circumferential wall of the housing. The segments can be screwed together, for example. The segments can be aligned with one another by locating pins.

In an embodiment of the bearing arrangement, it can be provided that the bearing arrangement has a sealing element. The sealing element can be fastened to an associated locking element. The sealing element can be formed integrally with the locking element. For example, the sealing element can be arranged on a side of the locking element axially facing away from the bearing. For example, the sealing element can seal the bearing on one side, for example, on an end face. The sealing element can be fastened to the locking element for the outer ring or to a further locking element for the inner ring. The sealing element can extend radially. A cover element can jointly form the sealing element and the locking element, for example, in one piece or with multiple segments. The sealing element can be formed to be annular. The sealing element can form a sealing surface radially on the inside and alternatively or additionally radially on the outside. The sealing element can form a labyrinth seal. The sealing element can be formed to be metallic. The sealing element can additionally hold seals, such as an O-ring. The sealing element seals, for example, on the rotor shaft and, alternatively or additionally, the housing. The sealing element seals, for example, the bearing on one end face, for example, on the rotor side or the generator side. The sealing element extends, for example, radially from the locking element to the rotor shaft. Alternatively, the sealing element extends, for example, from the further locking element to the housing. Two sealing elements can also be provided, for example, on axially opposite sides of the bearing. The sealing element can be screwed to the locking element.

In an embodiment of the bearing arrangement, it can be provided that the sealing element is formed in multiple parts. For example, each sealing element can be divided in the circumferential direction. For example, the respective sealing elements can have three segments, each extending 120° of a circular arc. The multi-part design allows for easy installation, for example, through an access opening in a circumferential wall of the housing. The segments can be screwed together, for example. The segments can be aligned with each other by locating pins.

In an embodiment of the bearing arrangement, it can be provided that the housing has at least one access opening on its circumferential wall, through which the axial force acting on the outer ring can be adjusted. Alternatively or additionally, the axial force acting on the inner ring can also be adjusted through the access opening. For example, respective locking elements, spacer elements, and, alternatively or additionally, sealing elements can be introduced into an interior space of the housing through the access opening. For example, respective locking elements, spacer elements, and, alternatively or additionally, sealing elements can be installed in an interior space of the housing through the access opening. For insertion through the access opening, it can be necessary to disassemble these elements into segments. For example, multi-part elements can be assembled in the interior space through the access opening. This can also be done when the bearings and, alternatively or additionally, the rotor shaft are already installed. The access opening can have one or more radial through-openings. The access opening can also reduce the weight of the housing. The access opening can be open during operation or closed by a cover, for example, in oil-tight manner, if the bearings are 'sealed. Multiple access openings can also be provided.

Alternatively or additionally, a generator housing can have at least one access opening on its circumferential wall, through which the axial force acting on the outer ring can be adjusted. This allows, for example, the preload on a generator-side bearing to be easily adjusted. The access opening can be designed as previously described for the housing. The bearing arrangement can comprise the generator housing or the entire generator.

In an embodiment of the bearing arrangement, it can be provided that the bearing arrangement has a further bearing. The further bearing can be axially spaced apart from the previously described bearing. The further bearing can form an O-arrangement or an X-arrangement with the previously described bearing. The further bearing can be designed in the same way as the previously described bearing. For example, one of the bearings can form a rotor-side bearing of the main bearing, and the further bearing can form a generator-side bearing of the main bearing. The further bearing can be fastened to the rotor shaft with its inner ring. The further bearing can be fastened in the housing, a connecting flange, or another component, such as the generator with its inner ring. For example, the further bearing can be fastened in the generator housing with its outer ring. The additional bearing can also be formed, for example, as a tapered roller bearing. The bearing arrangement can be formed to adjust an axial force acting on the outer ring of the further bearing in order to specify a preload of the further bearing. For this purpose, locking elements assigned to the additional bearing and optionally spacer elements can be provided, as previously described for the other bearing. A sealing element can also be provided. Alternatively, the preload of the further bearing can also be specified on the outer ring of the other bearing. The preload of the further bearing can therefore also be adjusted by applying pressure to the outer ring of the previously described bearing, for example, since overall a preload can result in an O-arrangement or X-arrangement.

In an embodiment, a wind turbine is provided having the fastening arrangement according to embodiments of the present disclosure. Respective advantages and further features can be gathered from the description of the embodiments of the present disclosure, wherein configurations of one embodiment can also form configurations of other embodiments. The wind turbine can have the rotor shaft. The wind turbine can comprise the tower, the nacelle, and the drive train. The rotor shaft or the entire drive train can be fastened to the nacelle by means of the bearing arrangement.

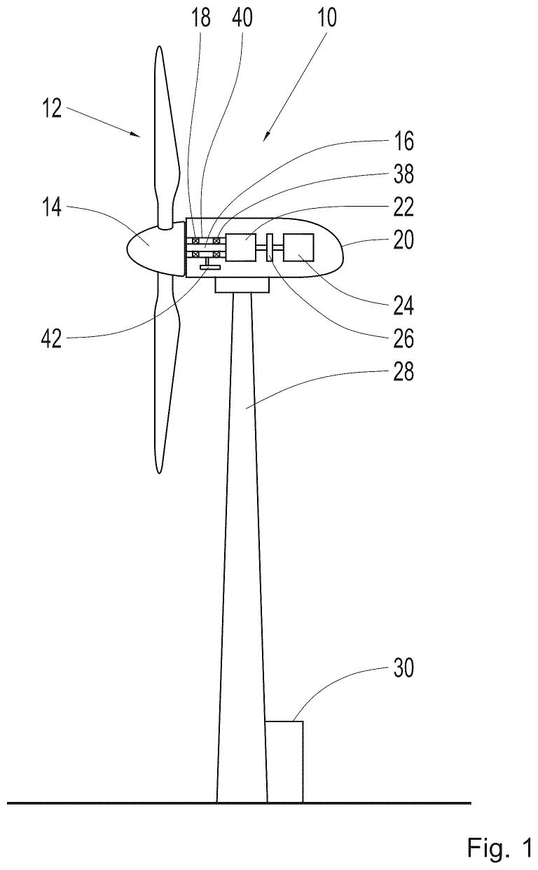

FIG. 1 illustrates a wind turbine 10 with a drive train of horizontal design. The wind turbine 10 has a rotor 12, which is held on a rotor shaft 16 via a hub 14. The axis of rotation of the rotor shaft 16 extends essentially horizontally. The rotor shaft 16 is mounted in a nacelle 20 via two rolling bearings 18, 38 formed as tapered roller bearings. For this purpose, a housing 40 is provided, which is fastened to a machine bed 42 of the nacelle 20. The two rolling bearings 18, 38 have an O-arrangement. The housing 40 and the two rolling bearings 18, 38 form a bearing arrangement for the rotor shaft 16. The rotor shaft 16 is mechanically operatively connected to a generator 24 via a gearbox 22. A brake 26 is also arranged in the operative connection between the gearbox 22 and the generator 24, which acts on an input shaft 76 of the generator 24. The nacelle 20 is rotatably mounted on an upper end of a tower 28, which is anchored to the ground. In another embodiment, the wind turbine 10 is formed as an offshore turbine. In addition to the tower 28, the wind turbine 10 also has a grid connection 30. A first of the rolling bearings 18 faces the rotor 12 and is also referred to as the rotor-side bearing 18. A second of the rolling bearings 38 faces the generator 24 and is also referred to as the generator-side rolling bearing 38.

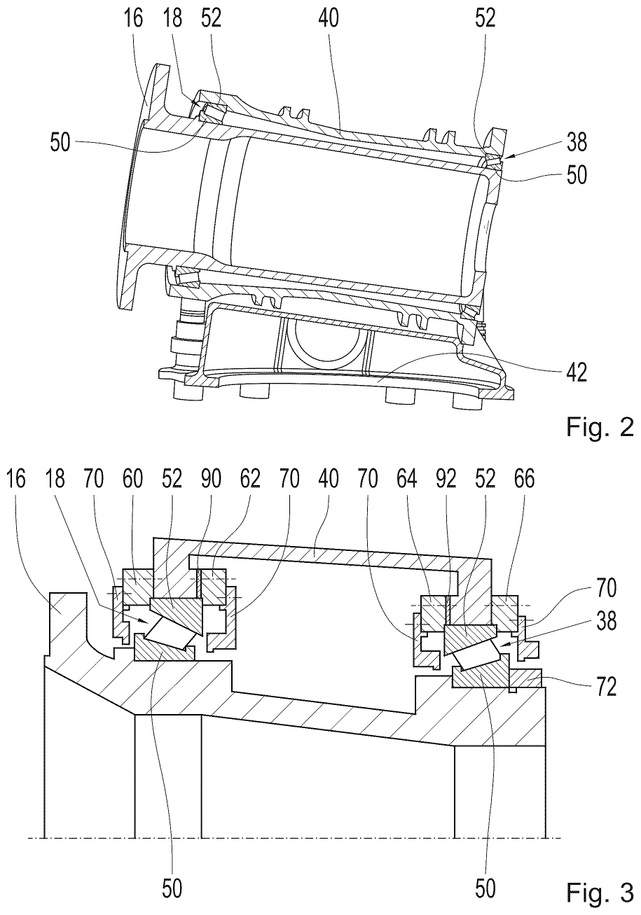

FIG. 2 illustrates a conventional bearing arrangement for the rotor shaft 16 of the wind turbine 10. A preload of the bearing arrangement is specified here by an axial force on an inner ring 50, with which the inner ring 50 is pressed axially in the direction of the rotor 12 via respective rolling elements of the second rolling bearing 38 against its outer ring 52. The two rolling bearings 18, 38 are mounted on the rotor shaft 16 with a radial interference fit, which makes the actual preload difficult to specify and highly temperature-dependent.

FIG. 3 shows a first embodiment of the bearing arrangement, in which the preload on the outer ring 52 of both the first rolling bearing 18 and the second rolling bearing 38 is adjustable. The outer ring 52 of the two rolling bearings 18, 38 is mounted on the housing 40 with a less tight fit, as a result of which the axial force can be specified precisely, easily, and less temperature-dependently by adjusting an axial force acting on the outer ring 52.

The inner ring 50 of the first rolling bearing 18 rests on its rotor side against a shoulder in the rotor shaft 16. The outer ring 52 of the first rolling bearing 18 is held at the end face in its axial position in the housing 40 on its rotor side by a first locking element 60. The first locking element 60 is detachably fastened to the housing 40, here by a screw connection. A sealing element 70 is fastened to the end face of the first locking element 60 on its rotor side, here also by a screw connection. The sealing element 70 extends radially to the rotor shaft 16 and seals the first rolling bearing 18 on the rotor side. The outer ring 52 of the first rolling bearing 18 is held in its axial position in the housing 40 on its generator side by a second locking element 62. A sealing element 70 is also fastened to the end face of the second locking element 62 on its generator side, here also by a screw connection. This sealing element 70 also extends radially to the rotor shaft 16 and thus seals the first rolling bearing 18 on the generator side.

A first spacer element 90 is clamped between the housing 40 and the second locking element 62, which here is screwed to the housing 40 together with the second locking element 62. The second locking element 62 presses the outer ring 52 of the first rolling bearing 18 with an axial force axially in the direction of the rotor 12 via the rolling elements of the first rolling bearing 18 against its inner ring 50, as a result of which a preload is specified. By selecting the first spacer element 90 from a set of spacer elements of different axial thicknesses, the axial force can be adjusted and thus the preload in the first rolling bearing 18 can also be specified. In other embodiments, alternatively or additionally, a spacer element from a set of spacer elements of different thicknesses is clamped between the first locking element 60 and the housing 40.

The inner ring 50 of the second rolling bearing 38 rests at the end face on its rotor side on a shoulder in the rotor shaft 16. On its generator side, the inner ring 50 of the second rolling bearing 38 is fixed in its axial position by a locking element 72, which is formed here as a nut. The outer ring 52 of the second rolling bearing 38 is held at the end face in its axial position in the housing 40 on its rotor side by a third locking element 64. The third locking element 64 is detachably fastened to the housing 40, here by a screw connection. A sealing element 70 is fastened to the end face of the third locking element 64 on its rotor side, here also by a screw connection. This sealing element 70 also extends radially to the rotor shaft 16 and seals the second rolling bearing 38 on the rotor side. The outer ring 52 of the second rolling bearing 38 is held in its axial position in the housing 40 by a fourth locking element 66 on its end face on the generator side. A sealing element 70 is also fastened to the fourth locking element 66 on its end face on the generator side, here also by a screw connection. This sealing element 70 also extends radially to the rotor shaft 16 and thus seals the first rolling bearing 18 on the generator side. This sealing element 70 seals on the locking element 72 instead of on the rotor shaft 16. In a further embodiment, this sealing element 70 also seals on the rotor shaft 16.

A second spacer element 92 is clamped between the housing 40 and the third locking element 64, which here is screwed to the housing 40 together with the third locking element 64. The third locking element 64 presses the outer ring 52 of the second rolling bearing 38 with an axial force axially in the direction of the generator 24 via the rolling elements of the second rolling bearing 38 against its inner ring 50, as a result of which a preload is specified. By selecting the second spacer element 92 from a set of spacer elements of different axial thicknesses, the axial force can be adjusted and thus the preload in the second rolling bearing 38 can also be specified. In other embodiments, alternatively or additionally, a spacer element from a set of spacer elements of different thicknesses is clamped between the fourth locking element 66 and the housing 40.

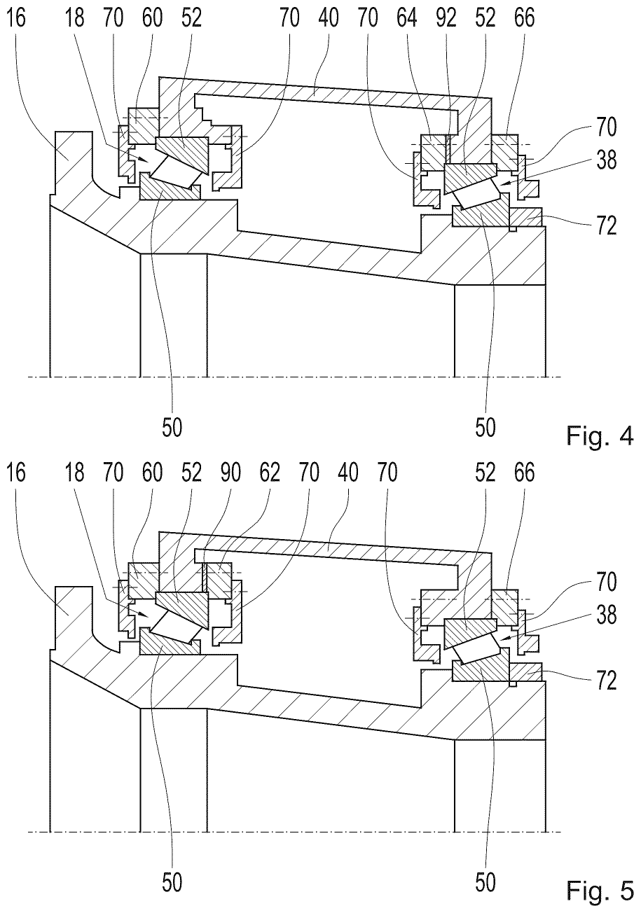

The numbering of the locking elements 60, 62, 64, 66 serves in this case the purpose of assignment. Further embodiments, such as the embodiment of FIG. 4 and the embodiment of FIG. 5, have fewer than four locking elements 60, 62, 64, 66, while the numbering of the remaining locking elements, whose position corresponds to one of the locking elements 60, 62, 64, 66 of the first embodiment, is retained. Accordingly, there can then be, for example, a first locking element 60 and a third locking element 64, but no second locking element 62. The same applies to the spacer elements 90, 92.

FIG. 4 illustrates a second embodiment of the bearing arrangement, which is similar to the first embodiment. Only differences are explained. In the second embodiment, the second locking element 62 is omitted. Instead, the housing 40 forms a shoulder in its place, on which the outer ring 52 of the first rolling bearing 18 is supported axially in the direction of the generator 24. The first spacer element 90 is thus also omitted. The preload of the bearing arrangement is now specified solely at the second rolling bearing 38 by the selection of the second spacer element 92. The sealing element 70 for sealing the first rolling bearing 18 on the generator side is now screwed directly to the housing 40. In another embodiment, this sealing element 70 is formed in one piece with the housing 40.

FIG. 5 illustrates a third embodiment of the bearing arrangement, which is similar to the second embodiment. Compared to the second embodiment, the sides on which the housing 40 forms a shoulder and on which the preload of the bearing arrangement can be adjusted have been swapped. Compared to the first embodiment, the third locking element 64 is therefore now omitted. Instead, the housing 40 forms a shoulder on which the outer ring 52 of the second rolling bearing 38 is supported axially in the direction of the rotor 12 on the end face. The second spacer element 92 is therefore also omitted. The preload of the bearing arrangement is now specified solely on the first rolling bearing 18 by the selection of the first spacer element 90. The sealing element 70 for sealing the second rolling bearing 38 on the rotor side is now screwed directly to the housing 40. In another embodiment, this sealing element 70 is formed in one piece with the housing 40.

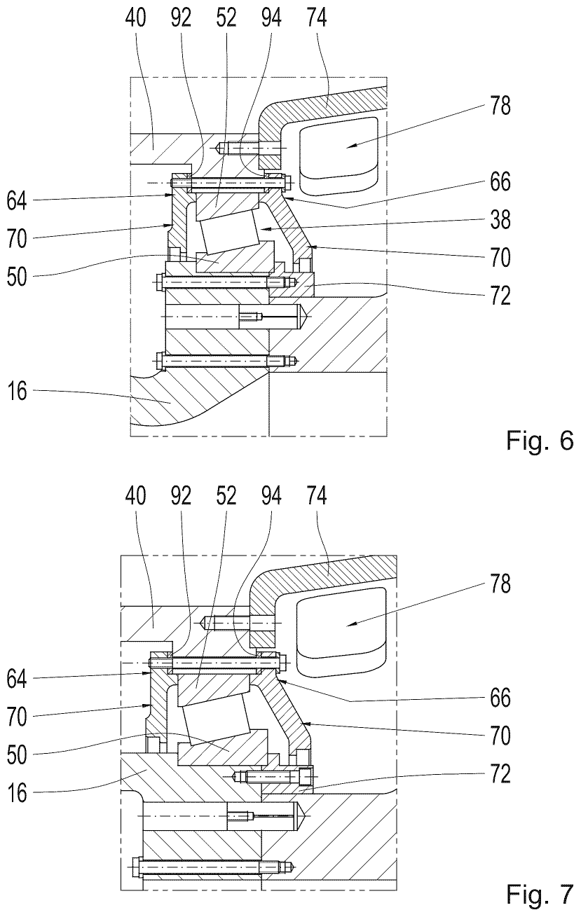

FIG. 6 illustrates a fourth embodiment of the bearing arrangement, in which only the second rolling bearing 38 and thus a generator-side end region of the rotor shaft 16 is shown.

A generator housing 74 is screwed to the end face of the housing 40. A rotor-side cover element forms both the third locking element 64 and the sealing element 70 extending therefrom as a common component. The second spacer element 92 is clamped between the third locking element 64 and the housing 40. A generator-side cover element forms both the fourth locking element 66 and the sealing element 70 extending therefrom as a common component. A third spacer element 94 is clamped between the fourth locking element 66 and the housing 40. The third locking element 64 and the fourth locking element 66 are jointly held on the housing 40 by a screw which extends through an axial through-opening on the housing 40. The screw connection of the generator housing 74 to the housing 40 and the screw connection of the third and fourth locking elements 64, 66 takes place from the side of the generator 24. For this purpose, the generator housing 74 has an access opening 78 in its circumferential wall.

The locking element 72 is now formed as an annular plate which is screwed to the rotor shaft 16 from the rotor 12 side and thus presses the inner ring 50 of the second rolling bearing 38 against the shoulder in the rotor shaft 16 for fastening. The locking element 72 sits radially outward on an input shaft 76 of the generator 24. The screw connection here takes place from the direction of the rotor 12. The rotor shaft 16 is also screwed to the input shaft 76 of the generator 24 from the rotor 12 side, which input shaft 76 is formed here by a planetary carrier of a planetary gear set of the generator 24. The rotor shaft 16 is screwed to the input shaft 76 at a radially outwardly extending flange of the rotor shaft 16, which also forms a seat for the inner ring 50 of the second rolling bearing 38. The screws are thus accessible radially outward past the rotor shaft 16.

In an embodiment, the locking element 72 is not screwed, but is fastened in some other way. In an embodiment, the locking element 72 is shrunk onto the input shaft 76 of the generator 24.

In an embodiment, a spacer element selected from a set of spacer elements of varying thickness is clamped between the locking element 72 and the rotor shaft 16. This allows the inner ring 50 of the second rolling bearing 38 to be clamped more tightly.

FIG. 7 illustrates a fifth embodiment of the bearing arrangement, which is similar to the fourth embodiment. Only differences are explained. The screw connection of the rotor shaft 16 to the input shaft 76 now takes place at a radially inwardly extending flange of the rotor shaft 16. The rotor shaft 16 has a central axial through-opening or recess through which the screws for connecting the rotor shaft 16 to the input shaft 76 are accessible. The locking element 72 is screwed to the rotor shaft 16 from the generator 24 side and thus presses the inner ring 50 of the second rolling bearing 38 against the shoulder in the rotor shaft 16 for fastening. The shape of the locking element 72 is correspondingly different here and, instead of a blind hole with an internal thread, now has a through-opening which has a generator-side end region with a wider diameter for countersinking a screw head.

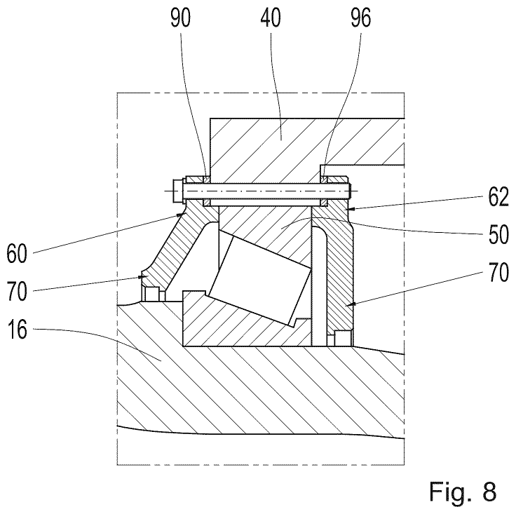

FIG. 8 illustrates a sixth embodiment of the bearing arrangement, in which only the first rolling bearing 18 and thus a rotor-side end region of the rotor shaft 16 are shown. The sixth embodiment has a cover element on the rotor side which, similar to the third and fourth embodiments, forms the first locking element 60 and the associated sealing element 70 as a single assembly. The sixth embodiment also has a cover element on the generator side which, similar to the third and fourth embodiments, forms the second locking element 62 and the associated sealing element 70 as a single assembly. The two cover elements are fastened to the housing 40 by a screw, also similar to the third and fourth embodiments. This screw is accessible from the direction of the rotor 12. The selected first spacer element 90 is clamped between the first locking element 60 and the housing 40. In addition, a further spacer element 96 is clamped between the second locking element 62 and the housing 40 on the generator side. As before, the inner ring 50 of the first rolling bearing 18 is pressed axially at the end face against a shoulder of the rotor shaft 16. The axially acting force and thus also the preload can be adjusted accordingly by adjusting the two spacer elements 90, 96.

FIGS. 9, 10, and 11 show a first, second, and third embodiment of the housing 40 of the bearing arrangement. The two rolling bearings 18, 38 are each arranged in axial end regions of the housing 40. The housing 40 according to the first embodiment, and thus of FIG. 9, has an access opening 80 axially centered in its circumferential wall, through which the corresponding screw connections in the housing 40 can be tightened and loosened. The housing 40 is reinforced in the region of the access opening 80 by intersecting struts, so that eight separate radial through-openings are formed in the circumferential wall.

The housing 40 according to the second embodiment, and thus of FIG. 10, has a first access opening 82 axially located in its circumferential wall at a rotor-side end region, through which the corresponding screw connections in the housing 40 in the region of the first rolling bearing 18 can be tightened and loosened. The housing 40 is reinforced in the region of the first access opening 82 by intersecting struts, so that eight separate through-openings are formed. In addition, the housing 40 has a second access opening 84 axially located in its circumferential wall at a generator-side end region, through which the corresponding screw connections in the housing 40 in the region of the second rolling bearing 38 can be tightened and loosened. The second access opening 84 has two aligned slots extending in the circumferential direction.

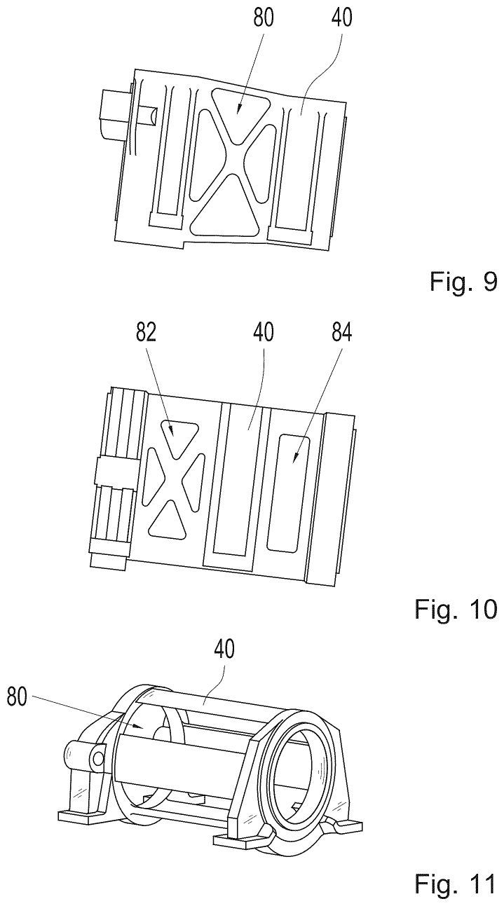

The housing 40 according to the third embodiment, and thus of FIG. 11, has an access opening 80 extending axially from the rotor-side end region to the generator-side end region in its circumferential wall, through which the corresponding screw connections on both sides in the housing 40 can be tightened and loosened. The access opening 80 is formed here by four slots extending axially from the rotor-side end region to the generator-side end region in the circumferential wall. The housings 40 are formed in one piece in the embodiments shown and in other embodiments in multiple parts.

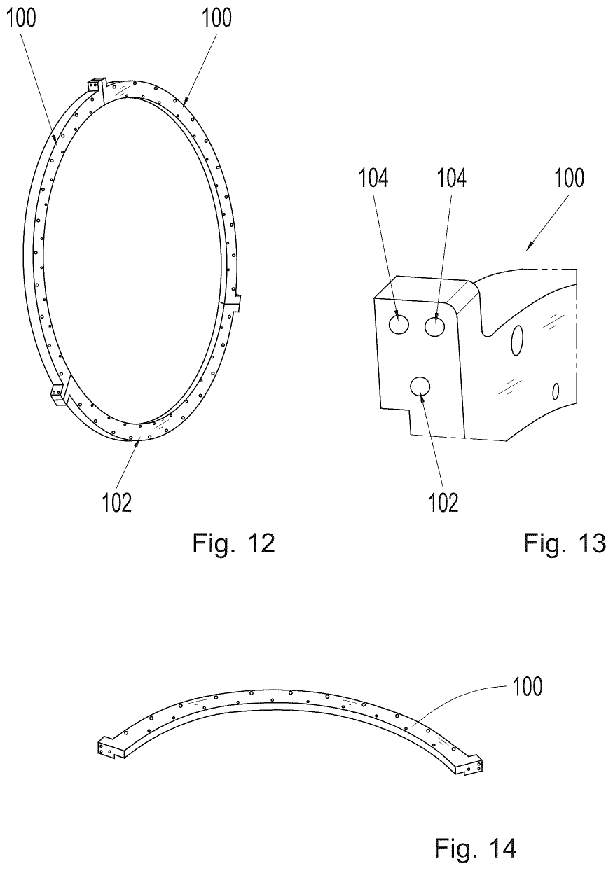

FIGS. 12 to 14 illustrate a cover element which, in the corresponding embodiments, forms one of the locking elements 60, 62, 64, 66 and the associated sealing element 70 together as an assembly. The cover element is circumferentially divided into three segments 100, which extend 120° around a circle. The segments 100 each have a flange on their end faces, with which they abut against an adjacent one of the segments 100. The flange has a blind hole 102 for a locating pin and two through-openings or, alternatively, blind holes with internal threads for connecting to the adjacent one of the segments 100. The segments 100 can be inserted into the interior through the access openings 80, 82, 84 of the housing 40 and mounted there. Each segment 100 jointly forms a segment of the corresponding locking element 60, 62, 64, 66 and the associated sealing element 70 in one piece. In other embodiments, the sealing elements 70 and the locking elements 60, 62, 64, 66 can be similarly segmented but formed separately. In further embodiments, the spacer elements 90, 92, 94 are also similarly segmented. Depending on the desired assembly, only some of the spacer elements 90, 92, 94, only some of the sealing elements 70, and, alternatively or additionally, only some of the locking elements 60, 62, 64, 66 are formed in a segmented manner.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

10 Wind turbine
12 Rotor
14 Hub
16 Rotor shaft
18 First rolling bearing
20 Nacelle
22 Transmission
24 Generator
26 Brake
28 Tower
30 Grid connection
38 Second rolling bearing
40 Housing
42 Machine bed
50 Inner ring
52 Outer ring
60 First locking element
62 Second locking element
64 Third locking element
66 Fourth locking element
70 Sealing element
72 Interlocking element
74 Generator housing
76 Input shaft of the generator
78 Access opening
80 Access opening
82 First access opening
84 Second access opening
90, 92, 94, 96 Spacer element
100 Segment
102 Blind hole

1. A bearing arrangement for a rotor shaft of a wind turbine, comprising:
a housing; and
at least one bearing,
wherein the at least one bearing is fastened in the housing with an outer ring,
wherein the at least one bearing is configured to be fastened to the rotor shaft with an inner ring, and
wherein the bearing arrangement is formed to adjust an axial force acting on the outer ring in order to specify a preload of the at least one bearing.

2. The bearing arrangement as claimed in claim 1, wherein the at least one bearing is formed as a tapered roller bearing.

3. The bearing arrangement as claimed in claim 1, wherein the bearing arrangement has a locking element detachably fastened to the housing and by which the outer ring is held in its axial position in the housing, and wherein at least one spacer element is configured to be clamped between the housing and the locking element for adjusting the force acting axially on the outer ring.

4. The bearing arrangement as claimed in claim 3, wherein the bearing arrangement has a further locking element detachably fastened to the rotor shaft, by which the inner ring is held in its axial position in the rotor shaft.

5. The bearing arrangement as claimed in claim 3, wherein the at least one spacer elements are formed in several parts.

6. The bearing arrangement as claimed in claim 3, wherein the locking element is formed in several parts.

7. The bearing arrangement as claimed in claim 3, wherein the bearing arrangement has a sealing element fastened to the locking element or is formed integrally with the locking element.

8. The bearing arrangement as claimed in claim 7, wherein the sealing element is formed in several parts.

9. The bearing arrangement as claimed in claim 1, wherein the housing has at least one access opening on a circumferential wall of the housing, through which the axial force acting on the outer ring is configured to be adjusted.

10. The bearing arrangement as claimed in claim 1, wherein the bearing arrangement has a generator housing, wherein the generator housing has at least one access opening on a circumferential wall of the generator housing, through which the axial force acting on the outer ring is configured to be adjusted.

11. The bearing arrangement as claimed in claim 1, wherein the bearing arrangement has a further bearing, wherein the at least one bearing and the further bearing have an O-arrangement.

12. A wind turbine with the bearing arrangement according to claim 1.
